(19) United States
(12) Patent Application Publication
(10) Pub. No.: US 2004/0101310 A1
(43) Pub. Date: May 27, 2004

(54) Computer pen apparatus

(76) Inventor: Michael Sujue Wang, Morganville, NJ (US)

Correspondence Address: Mr. Walter J. Tencza Jr., Suite 3, 10 Station Place, Metuchen, NJ, 08840, US

(21) Appl. No.: 10/679,525

(22) Filed: Oct. 6, 2003

Related U.S. Application Data
(63) Continuation-in-part of application No. 10/302,389, filed on Nov. 21, 2002.

(51) Int. Cl. H04B 10/00

(52) U.S. Cl. 398/140

(57) ABSTRACT

The present invention, in one or more embodiments, provides an apparatus comprising an optical transmitter and an optical receiver located in a pen shaped housing. The apparatus may be further comprised of a processor. The optical transmitter may send out optical signals toward a surface and the optical receiver may receive the optical signals reflected off of the surface. The processor may process the optical signals received by the optical receiver to determine the location or movement of the pen shaped housing.

### CROSS REFERENCE TO RELATED APPLICATION(S)

The present application is a continuation in part of and claims the priority of parent U.S. patent application Ser. No. 10/302,389, titled “COMPUTER PEN APPARATUS”, filed on November 21, 2002, inventor and applicant Michael Sujue Wang.

### FIELD OF THE INVENTION

This invention relates to improved methods and apparatus concerning inputting information into a computer processor and/or computer memory and controlling a computer cursor on a computer monitor.

### BACKGROUND OF THE INVENTION

Tools such as a computer mouse, a computer keyboard, a microphone and a video camera provide convenient ways for people to record and edit text, as well as audio and video information into computer memory. This information can be stored on a disc and transferred over the Internet. However, these tools are not convenient for writing signatures or for drawing graphic information to be stored into computer memory.

### SUMMARY OF THE INVENTION

The present invention in one or more embodiments provides an apparatus, which is used like a pen but functions like a computer mouse. The apparatus is easy to use for writing signatures and drawing graphic information to be entered into computer memory. The apparatus is designed as a graphing interactive tool between human and machine (computer). The apparatus may have the same control function as a computer mouse but have the shape of a pen. The pen shaped apparatus and a prior art computer mouse can be combined in a partially or fully integrated apparatus. Typically, an operator would use the pen shaped apparatus for entering signatures and drawings into computer memory, and the operator would use the prior art computer mouse for normal cursor control.

The pen shaped apparatus or device of embodiments of the present invention may be used to drive rotation of an x-axis control device and a y-axis control device, which control the horizontal and vertical movement, respectively, of a computer cursor on a computer monitor.

The pen shaped apparatus may be provided with a plurality of balls, wherein the rotation of the balls controls the movement of a computer cursor on a computer monitor. The apparatus may also include a pen shaped housing in which is located the plurality of balls. Another apparatus is provided which includes a device for substantially fixing a computer mouse at a location; and a device for rotating a ball of the computer mouse, while the computer mouse is substantially fixed at the location. A computer keyboard is also provided comprising a typing area, an area in which a computer mouse can be fixed in a location, the computer mouse including a ball, and an area which is responsive to the movement of an implement so that the movement of the implement causes movement of the ball of the computer mouse and thereby controls a computer cursor on a computer monitor.

The present invention, in one or more embodiments, provides an apparatus comprising an optical transmitter, an optical receiver; and a pen shaped housing in which the optical transmitter and the optical receiver are located. The apparatus may be further comprised of a processor. The optical transmitter may send out optical signals toward a surface and the optical receiver may receive the optical signals reflected off of the surface. The processor may process the optical signals received by the optical receiver to determine the location or movement of the pen shaped housing.

The pen shaped housing may have a tip and the optical transmitter may send out optical signals towards an area near the tip. The optical receiver may receive optical signals reflected off an area near the tip. The tip may be centered at one end of the pen shaped housing. The apparatus may be further comprised of a wireless transmitter. The wireless transmitter may transmit wireless signals specifying the location or movement of the pen shaped housing based on the received optical signals processed by the processor. A wireless modulator may also be provided which supplies the wireless signals to the wireless transmitter based on the received optical signals processed by the processor.

The tip of the pen shaped housing may be closed. The pen shaped housing may include a heat release window. The tip may be transparent. The tip may be partially transparent and partially opaque.

The apparatus may be comprised of a first ball and one or more further balls. The optical transmitter may send out optical signals toward a surface of the first ball and the optical receiver may receive the optical signals reflected off of the surface of the first ball. The processor may process the optical signals received by the optical receiver to determine the location or movement of the pen shaped housing.

The present invention also includes a method comprising sending out optical signals toward a surface, receiving the optical signals reflected off of the surface, and processing the optical signals received to determine the location or movement of a pen shaped housing.

### BRIEF DESCRIPTION OF THE DRAWINGS

FIG. 1 is a diagram demonstrating the operation a track ball or the ball of a computer mouse as known in the art;

FIG. 2 shows a diagram of an apparatus in accordance with an embodiment of the present invention;

FIG. 3 shows a front view of the apparatus of FIG. 2 along with a computer connection device;

FIG. 4 shows a diagram of an apparatus in accordance with a second embodiment of the present invention wherein a computer pen lies outside a computer penholder;

FIG. 5 shows the apparatus of FIG. 4 wherein the computer pen lies inside the computer penholder;

FIG. 6A shows a top view of an apparatus in accordance with another embodiment of the present invention with the apparatus in a first state;

FIG. 6B shows a top view of the apparatus of FIG. 6A with the apparatus in a second state;

FIG. 6C shows a top view of the apparatus of FIG. 6B with the apparatus in a third state;

FIG. 7A shows a top view of an apparatus in accordance with another embodiment of the present invention with the apparatus in a first state;

FIG. 7B shows a top view of the apparatus of FIG. 7A with the apparatus in a second state;

FIG. 7C shows a top view of the apparatus of FIG. 7B with the apparatus in a third state;

FIG. 8A shows an apparatus in accordance with another embodiment of the present invention wherein an implement is located in a first position with respect to a surface;

FIG. 8B shows the apparatus of FIG. 8A wherein the implement is located in a second position with respect to the surface of FIG. 8A;

FIG. 8C shows the apparatus of FIG. 8A wherein the implement is located in a third position with respect to the surface of FIG. 8A;

FIG. 9A shows an apparatus in accordance with another embodiment of the present invention wherein an implement is located in a first position with respect to a surface;

FIG. 9B shows an apparatus in accordance with another embodiment of the present invention wherein the implement of FIG. 8A is located in a second position with respect to the surface of FIG. 9A;

FIG. 9C shows an apparatus in accordance with a another embodiment of the present invention wherein the implement of FIG. 9A is located in a third position with respect to the surface of FIG. 9A;

FIG. 10 is a top view diagram which shows the location of some of the components of the apparatus of FIG. 9A at a first instant of time when the implemented is located at a first position and at a second instant of time when the implement is located at a second position;

FIG. 11A is a top view diagram of portions of an apparatus in accordance with another embodiment of the present invention wherein first and second rails cause a pad to react to movements by an implement; and wherein the implement is in a first position and the pad is in a second position;

FIG. 11B is a top view diagram of portions of the apparatus of FIG. 10A wherein the implement is in a third position and the pad is in a fourth position;

FIG. 11C is a top view diagram of portions of the apparatus of FIG. 10A wherein the implement is in a fifth position and the pad is in a sixth position;

FIG. 12 is a block diagram of a keyboard device in accordance with another embodiment of the present invention;

FIG. 13A is a side view of components of another embodiment in accordance with the present invention with pressure not applied to an implement;

FIG. 13B is a side view of the components of FIG. 13A with pressure applied to the implement of FIG. 13A;

FIG. 14A is a side view of components of another embodiment in accordance with the present invention with pressure no applied to an implement;

FIG. 14B is a side view of the components of FIG. 14A with pressure applied to the implement of FIG. 14A;

FIG. 15 is a top view of components of the embodiment of FIGS. 13A and 13B;

FIG. 16A is a diagram of an apparatus in accordance with another embodiment of the present invention;

FIG. 16B is a side view of a gear for use with the apparatus of FIG. 16A;

FIG. 17A is a diagram of a pen like apparatus with a symmetric pen tip in accordance with another embodiment of the present invention;

FIG. 17B is a diagram of a pen like apparatus with an asymmetric pen tip in accordance with another embodiment of the present invention;

FIG. 18 is a diagram of a pen like apparatus with a heat release window in accordance with another embodiment of the present invention; and

FIG. 19 is a diagram of a pen like apparatus with a heat release window and X and Y axis coding balls in accordance with another embodiment of the present invention.

### DETAILED DESCRIPTION OF THE DRAWINGS

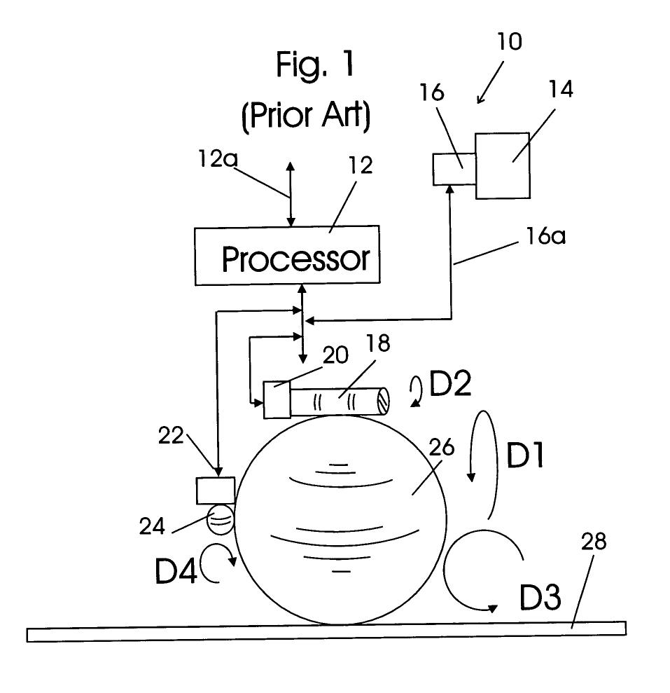

FIG. 1 is a diagram 10 demonstrating the operation a track ball or the ball of a computer mouse as known in the art. The diagram 10 shows a mouse-clicking device 14 (such as a left clicking device or right clicking device). The mouse-clicking device 14 is connected to a device 16, which translates the click of device 14 into an electrical signal. The diagram 10 also includes a processor 12, which may for example be a personal computer processor. The diagram 12 also shows a ball 26, an X-axis control device 24 and a Y-axis control device 18. The X-axis control device 24 and the Y-axis control device 18 are connected to devices 22 and 20, which translate the rotation of the devices 24 and 18, respectively, into electrical signals.

In operation, as known in the art, the ball 26 rotates in some direction. The rotation of the ball 26 causes the rotation of one or both of the X-axis control device 24 and/or the Y-axis control device 18, depending on how the ball 26 is rotated. Rotation of the ball 26 may occur by frictional engagement with a surface 28 (such as typically the case for a computer mouse) or with a hand or finger (such as a typically the case with a trackball). For example, if the ball 26 is rotated in the direction D1 then the ball 26, by frictionally engaging the Y-axis control device 18 causes the Y-axis control device 18 to rotate in the direction D2, which is opposite the direction D1. For rotation of the ball 26 in the direction D1, there is no rotation of the X-axis control device 24. If the ball 26 is rotated in a direction D3 then the ball 26, by frictionally engaging the X-axis control device 24 causes the X-axis control device 24 to rotate in the direction D4, which is opposite the direction D3. For rotation of the ball 26 in the direction D3, there is no rotation of the Y-axis control device 18. If the ball 26 rotates in a direction which is a combination of X and Y movement), then both the X-axis control device 24 and the Y-axis control device 18 would rotate.

The X-axis control device 24 is used to control a computer cursor's movement in a horizontal direction. The Y-axis control device 18 is used to control a computer cursor's movement in a vertical direction.

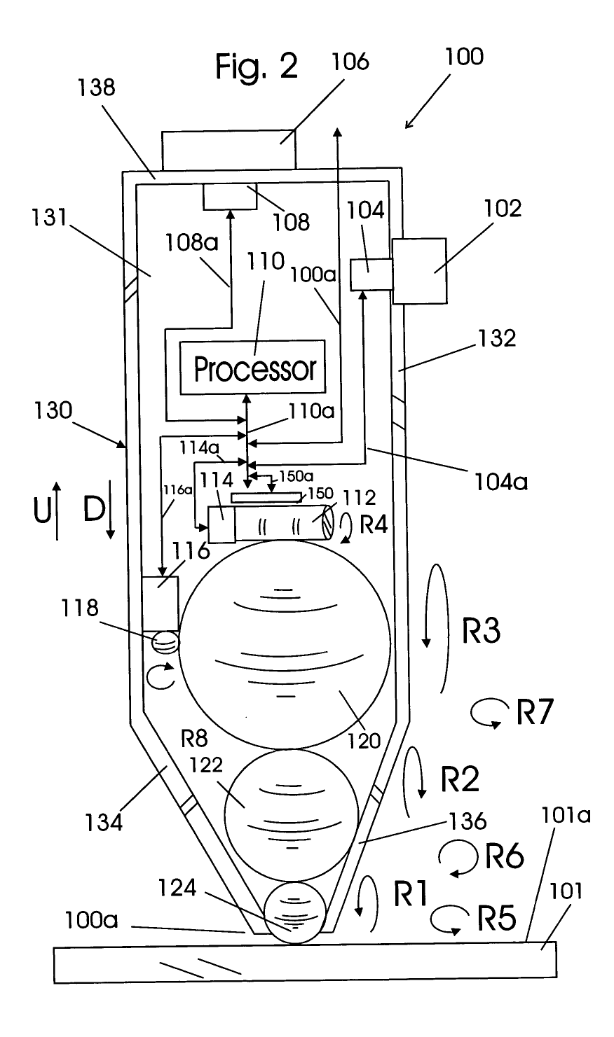

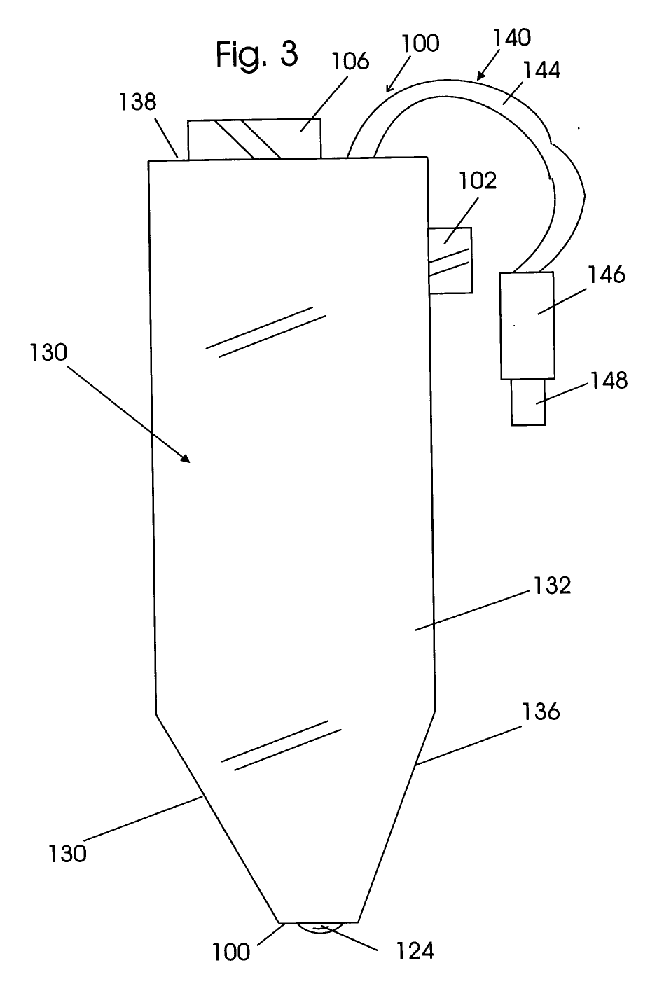

FIG. 2 shows a diagram of an apparatus 100 in accordance with an embodiment of the present invention. FIG. 3 shows a front view of the apparatus 100 of FIG. 2 along with a computer connection device 140.

The apparatus 100 includes a first clicking device 102, a device 104, a second clicking device 106, a device 108, a processor 110, a Y-axis control device 112, a device 114, an X-axis control device 118, a device 116, a ball 120, a ball 122, a ball 124 and a housing 130. The housing 130 is shown in cross section form in FIG. 2 and a front view of the housing 130 is shown FIG. 3. The housing 130 may in the shape of the housing for a pen. The housing 130 may be comprised of a body portion 132, an inclined portion 134, an inclined portion 136, and a top portion 138.

The clicking device 102 is connected to the device 104. The device 104 is electrically connected to the processor 110 by a communications line 104a and a bus 110a. The clicking device 106 is electrically connected to the device 108. The device 108 is electrically connected to the processor 110 by a communications line 108a and the bus 110a. The X-axis control device 118 is connected to the device 116. The device 116 is electrically connected to the processor 110 via communications line 11 6a and the bus 110a. The Y-axis control device 112 is connected to the device 114. The device 114 is electrically connected to the processor 110 via communications line 114a and the bus 110a. The bus 110a may be electrically connected to another processor such as a personal computer processor by a communications line 100a. Alternatively, the processor 110 may lie outside the housing 130. The processor 110 may be called a “control processor/circuit” and may be a chipset or circuit inside the housing 130. The processor 110 may process the x-axis and the y-axis signals. If the apparatus 100 is optical based, the apparatus 100 may need an extra processor or circuit beyond the X-axis control device 116 and Y-axis control device 112. The bus 110a and/or 100a may electrically connect the processor 110 to an outside processor such as a computer processor. Electrical connections, generally in this application, may be wired, wireless, optical, or any type of communications connections.

In operation, when the ball 124 rotates in a direction such as R1, the ball 124, by frictionally engaging the ball 122, causes the ball 122 to rotate in an opposite direction such as R2. The ball 122, by frictionally engaging the ball 120, causes the ball 120 to rotate in a direction R3, which is opposite R2. The rotation of the ball 120 causes the Y-axis control device 112 to rotate in a direction R4 that is opposite R3. The device 114 produces an electrical signal, which depends on the degree of rotation of the Y-axis control device 112. An operator can cause the ball 124 to rotate by moving the apparatus 100 with respect to the surface 101a of the mouse pad 101, while the ball 124 frictionally engages the surface 101a.

Similarly, when the ball 124 rotates the direction R5, the ball 124, by frictionally engaging the ball 122, causes the ball 122 to rotate in an opposite direction such as R6. The ball 122, by frictionally engaging the ball 120, causes the ball 120 to rotate in a direction R7, which is opposite R6. The rotation of the ball 120 causes the X-axis control device 118 to rotate in a direction R8 that is opposite R7. The device 116 produces an electrical signal, which depends on the degree of rotation of the X-axis control device 118.

The electrical signals from the devices 114 and 116 are sent to the processor 110 or directly to a computer processor outside the housing 130. The processor 110 or a processor outside of the housing 130 to determine how to move a computer cursor on a computer monitor uses the electrical signals from the devices 114 and 116. For example, the computer cursor may move a distance y1 upwards on the computer monitor in response to a rotation of ball 124 of 10 degrees in the R1 direction. Also, the computer cursor may move a distance x1 to the right on the computer monitor in response to rotation of ball 124 10 degrees in the R5 direction.

The clicking device 106 located on or near the top 138 of the housing 130 may have a function similar to a left or right clicking device on a typical computer mouse. The clicking device 102 located on the body portion 132 of the housing 130 may also have a function similar to the left or right clicking device on a typical computer mouse. The housing 130 should encapsulate all of the components in a closed chamber having 131 having only an opening for the ball 124, openings for the clicking devices 102 and 106 and/or the devices 104 and 108. The top 138 of the housing 130, may however be detachable from the housing 130, or the housing 130 may be able to be separated into two pieces to reveal the components inside the housing 130.

The apparatus 100 may include a clicking device 150. In operation, if an individual moves the housing 130 downwards in a direction D against the surface 101a of the mouse pad 101, the clicking device 150 may move downwards in the direction D along with housing 130 while the devices 112 and 114 (along with balls 120, 122, and 124) remain stationary. When, the housing 130 has moved a sufficient distance with respect to ball 124 (and with respect to balls 120, 122, and device 112 and 114) then one or both of devices 112 and 114 come in contact with clicking device 150. The contacting of device 150 with devices 112 and/or 114 causes a signal to be sent along a bus 150a and along bus 110a to the processor 110. This signal may be used, as a typical computer “click” signal to select a field or item on a computer monitor. The clicking device 150 may be fixed to the housing 130 so that the clicking device 150 moves with respect to the housing 130, while the devices 112 and 114 may be connected for example, by a spring to the housing 130 or to the clicking device 150 so that the devices 112 and 114 may move with respect to the housing 130.

As shown by FIG. 3, the apparatus 100 may be electrically connected to a computer connection device 140. The computer connection device may be adaptable for electrically connecting the apparatus 100 to a computer processor of a personal computer. The computer connection device 140 may include a cable 144, a connection portion 146 and a connector portion 148. The cable 144 may be comprised of an insulated covering with one or more conductors inside. The one or more conductors may be electrically connected the communications lines in FIG. 2, such as communication lines 116a (from X-axis control device 118), 114a (from Y-axis control device 112), 104a (from clicking device 102), and 108a (from clicking device 106) or the communications line 100a (from the processor 110). The one or more conductors in the cable 144 continue to run under the connection portion 146 and the portion 148. The portion 148 can be electrically connected to a port of a personal computer.

The use of more than one ball, such as the example of balls 124, 122, and 120 in FIG. 2, allows a small ball to be provided at the tip 100a of the apparatus 100. This allows for more comfortable writing. Any number of balls can be provided, and in some embodiments only one ball will be provided. However, it is preferred to use multiple balls, and the use of multiple balls is an important aspect of the present invention. A small ball alone, such as ball 124, results in low accuracy for control of a computer cursor. The increase in size of the balls from 124 to 122 to 120 in FIG. 2, increases the resolution, or accuracy of a computer cursor on a computer monitor, when the computer cursor is controlled by the apparatus 100.

If one wants the apparatus or computer pen 100 to function similarly to a computer mouse, then an odd number of balls would be used, such as the three balls 120, 122, and 124 in FIG. 2. However, one can use an even number of balls if the devices 114 and 116 electronically adjust for opposite rotation. I.e. the last ball 120 (assuming there are an even number of balls with 120 still last) would rotate in an opposite direction from ball 124 and the devices 114 and 116, or some other devices, would have to account for this in determining the electrical signals to control a computer cursor.

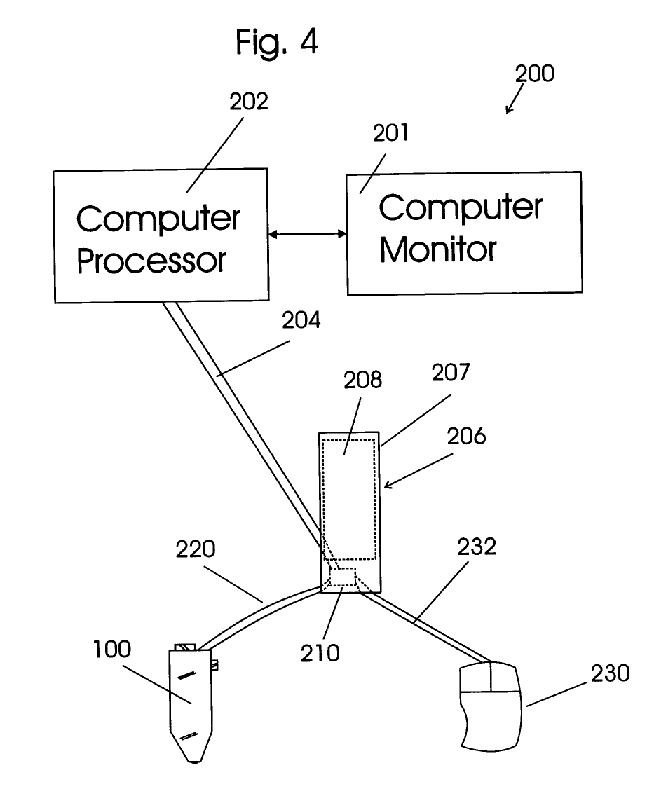

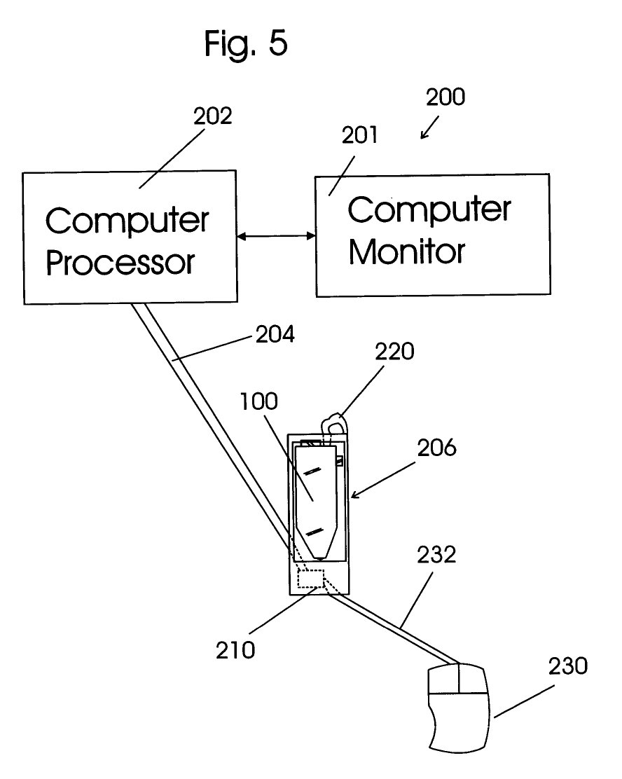

FIG. 4 shows a diagram of an apparatus 200 in accordance with a second embodiment of the present invention wherein the apparatus 100 lies outside a computer penholder 206. FIG. 5 shows the apparatus of FIG. 4 wherein the apparatus 100 lies inside the computer penholder 206. The apparatus 200 includes a computer processor 202, a computer penholder 206, and a computer mouse 230. The apparatus 100 is electrically connected to a switch 210 of the computer penholder 206 by a computer connection device or cable 220. The computer mouse 230 is electrically connected to the switch 210 by a computer connection device or cable 232. The computer penholder 206 includes a substantially enclosed chamber 208 surrounded by a body 206. The computer penholder 206 may have a cup shape.

In operation, when the apparatus 100 (or computer pen) is not in the chamber 208 of the computer pen holder 206, then the switch 210 causes the apparatus 100 to be electrically connected to the computer processor 202 through communications line 220, switch 210, and communication line 204 so that the apparatus 100 controls the computer cursor on the computer monitor 201. At this same time the switch 210 disconnects the computer mouse 230 from the computer processor 202.

When the apparatus 100 is in the chamber 206 as shown in FIG. 5, then the switch 210 may sense the presence of the apparatus 100 and may cause the computer mouse 230 to be electrically connected to the computer processor 202 through communication lines 232, switch 210, and communications line 204 so that the computer mouse 230 controls the computer cursor on the computer monitor 201. At this same time the switch 210 disconnects the computer pen or apparatus 100 from the computer processor 202.

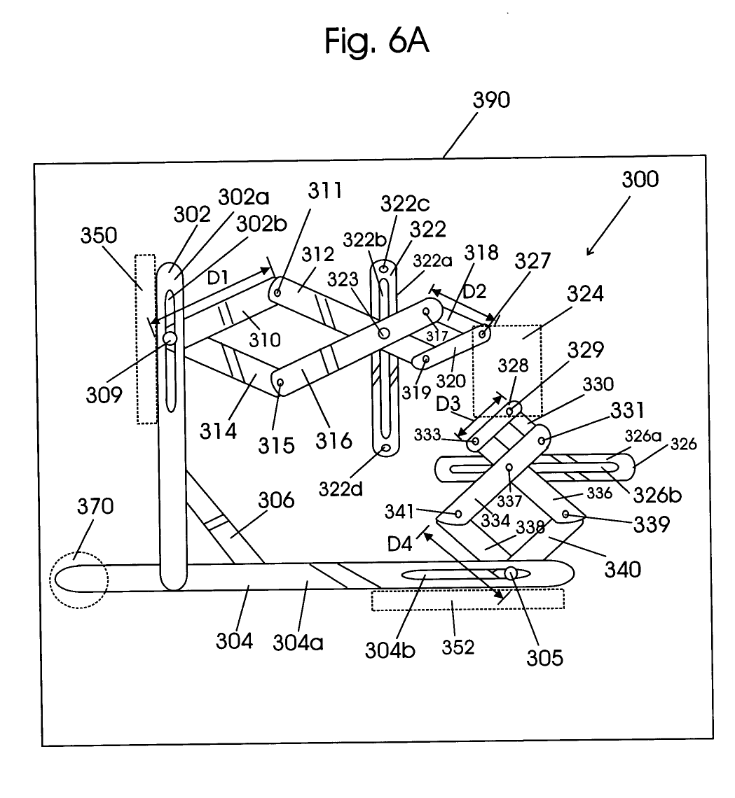

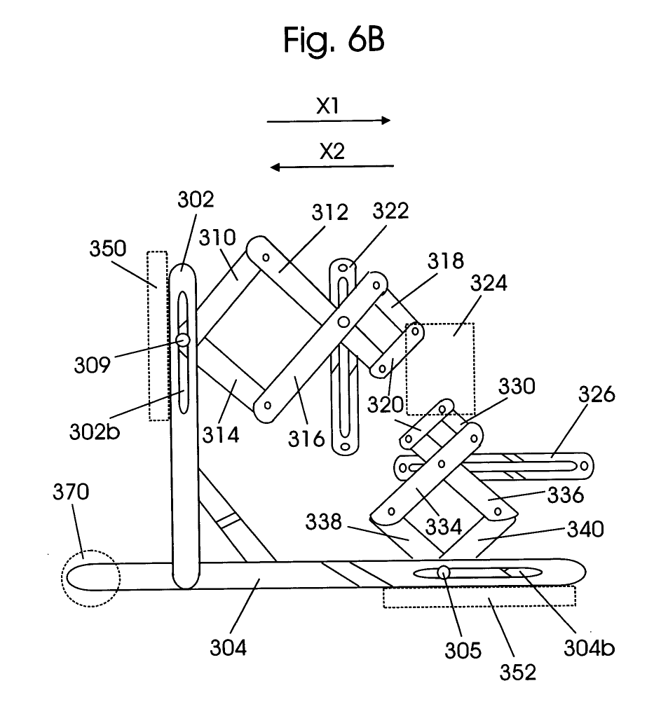

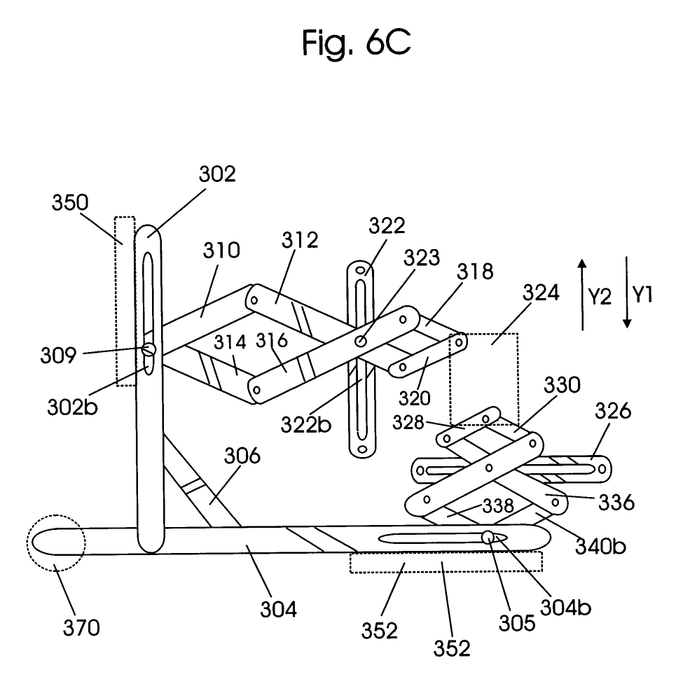

FIG. 6A shows a top view of an apparatus 300 in accordance with another embodiment of the present invention with the apparatus 300 in a first state. FIG. 6B shows a top view of the apparatus 300 of FIG. 6A with the apparatus 300 in a second state. FIG. 6C shows the apparatus 300 in a third state.

The apparatus 300 is comprised components which mechanically connect an implement 370 with a pad 324. The implement 370 may be in the shape or form of a pen and may be used to control the pad 324. The pad 324 may be located under or above a typical computer mouse ball and movement of the pad 324 may cause the computer mouse ball to move and may thereby control a computer cursor on a computer monitor.

The apparatus 300 is comprised of a member 302, a member 304, a member 306, a member 322, and a member 326. The apparatus 300 is also comprised of a device 380 and a device 382. The device 380 is comprised of members 310, 312, 314, 318, and 320. The device 380 connects the member 302 with the pad 324. The members 310 and 312 are rotatably connected together by a screw or pin 311. The members 314 and 316 are rotatably connected together by a screw or pin 315. The members 310 and 314 are rotatably connected together by a screw or pin 309. The members 312 and 316 are rotatably connected together by a pin or screw 323. The members 316 and 318 are rotatably connected together by a pin or screw 317. The members 312 and 320 are rotatably connected together by a pin or screw 319. The members 318 and 320 are rotatably connected together by a pin screw 327.

The member 302 is comprised of a body portion 302a and a slot 302b. The pin or screw 309 fits into a slot 302b inside the member 302. The pin or screw 309 can slide up and down the slot 302b. The member 322 is comprised of a body portion 322a and a slot 322b. The pin or screw 323 can slide up and down the slot 322b.

The device 382 is comprised of members 328, 330, 332, 334, 336, 338, and 340. The device 382 connects the member 304 with the pad 324. The members 338 and 334 are rotatably connected together by a screw or pin 341. The members 340 and 336 are rotatably connected together by a screw or pin 339. The members 338 and 340 are rotatably connected together by a screw or pin 305. The members 334 and 336 are rotatably connected together by a pin or screw 337. The members 336 and 328 are rotatably connected together by a pin or screw 333. The members 330 and 334 are rotatably connected together by a pin or screw 331. The members 330 and 328 are rotatably connected together by a pin screw 329.

The member 304 is comprised of a body portion 304a and a slot 304b. The pin or screw 305 fits into a slot 304b inside the member 304. The pin or screw 305 can slide across the slot 304b. The member 326 is comprised of a body portion 326a and a slot 326b. The pin or screw 337 can slide across the slot 326b.

The pad 324 is connected to the pin 327 and to the pin 329. The members 322 and 326 are fixed to a surface 390 which does not move during proper operation of the implement 370 and pad 324. The members 322 and 326 are perpendicular to one another. The member 302 can move up in the direction Y2 or down in the direction Y1 shown in FIG. 6C. The member 302 can move to the left in the direction X2 and to the right in the direction X1 as shown in FIG. 6B. However, the member 302 remains parallel to the member 322 during any movement of the member 302. Device 350, which may be comprised of a sliding rail or track, may be used to keep member 302 parallel to member 322 during movement of member 302.

The member 304 can move up in the direction Y2 or down in the direction Y1 shown in FIG. 6C. The member 304 can move to the left in the direction X2 and to the right in the direction X1 as shown in FIG. 6B. However, the member 304 remains parallel to the fixed member 326 during any movement of the member 304. Device 352, which may be comprised of a sliding rail or track, may be used to keep member 304 parallel to member 326 during movement of member 304. The member 302 is fixed at a right angle to the member 304. A support 306 may also be used to connect member 302 to member 304.

In the example of FIGS. 6A-6C, the member 310 is D1 inches long and the member 318 is D2 inches long. D1 may be set to be twice the length of D2. For that case, for every two inches of movement of implement 370, the pad 324 will move one inch. Generally the members 318 and 320 will be the same length. The distance between the end of member 316 near member 318 and the pin 323, as well as the distance between the end of member 312 near member 320, will also be the same length as members 318 and 320. Members 310 and 314 will generally be the same length. The distance between the end of member 316 near member 314 and the pin 323, and the distance between the end of member 312 near the member 310 and the pin 323, will be the same length as members 310 and 314.

In operation, an individual may move the implement or pen 370, in the direction X1, from the state or position of FIG. 6A to the state or position of FIG. 6B. The movement of the pen 370 to the right, causes the member 304 to also move to the right (i.e. direction X1). Assuming that the individual moves the pen 370 two inches, then the member 304 will also move two inches. The member 302 and the device 350 will also move two inches to the right. The members 310, 314, 312, 316, 318, and 320 will flex or rotate from the position shown in FIG. 6A to the position shown in FIG. 6B. The pins 309 and 323 remain stationary in the slots 302b and 322b, respectively. The pad 324 moves to the left, in direction X2, by being pulled by members 318 and 320 through pin 327. The device 382 is not flexed but merely moves to the left, in the direction X2 by being pulled by pad 324 through pin 329. The pin 337 slides through slot 326b. The pad 324 moves one inch to the left in response to two inches of movement of the implement 370 to the right, from the state of FIG. 6A to the state of FIG. 6B.

In operation, an individual may move the implement or pen 370, in the direction Y2, upwards, from the state or position of FIG. 6A to the state or position of FIG. 6C. The movement of the pen 370 upwards, causes the member 304 to also move upwards. Assuming that the individual moves the pen 370 two inches, then the member 304 will also move two inches. The member 302 and the device 350 will also move two inches upwards in the direction Y2. The members 328, 330, 334, 336, 338, and 340 of the device 382, will flex or rotate from the position shown in FIG. 6A to the position shown in FIG. 6C. The pins 305 and 337 remain stationary in the slots 304b and 326b, respectively. The pad 324 moves downwards, in the direction Y1, by being pulled by members 328 and 339 through the pin 329. The device 380 is not flexed but merely moves downwards, in the direction Y2 by being pulled by pad 324 through pin 329. The pin 323 slides through slot 322b. The pin 309 slides downwards through slot 302b. The pad 324 moves one inch downwards in response to two inches of movement of the implement 370 upwards, from the state of FIG. 6A to the state of FIG. 6C.

The pad 324 may be located under a computer mouse ball and may be frictionally engaged with a computer mouse ball so that when the pad 324 moves the computer mouse ball moves and a computer cursor on a computer monitor is thereby controlled.

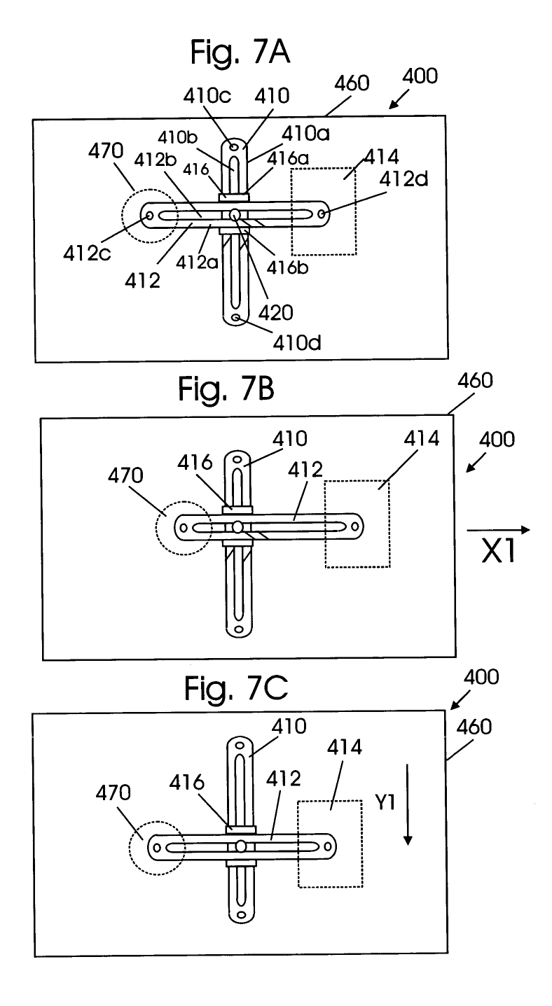

FIG. 7A shows a top view of an apparatus 400 in accordance with another embodiment of the present invention with the apparatus 400 in a first state. The apparatus 400 includes a member 410, a member 412, an implement 470, and a pad 414. The member 410 includes a body portion 410a, a slot 410b, and screws 410c and 410d for fixing the member 410 to a surface such as surface 460. The member 412 includes a body portion 412a, a slot 412b, and screws 412c and 412d for fixing the member 412 to the implement 470 and the pad 414 respectively. The apparatus 400 may also include a slide 416 comprised of portions 416a and 416b, which can be used to keep the member 410 perpendicular to the member 412. The member 410 may be connected to the member 412 through a pin 420.

In operation an individual may move the implement 470 to the right, in the direction X1, from the position or state of FIG. 7A to the position or state of FIG. 7B. The movement of the implement 470 to the right, causes the pad 414 to move towards the right. In this manner the pad 414 tracks the movement of the pen or implement 470. An individual may also move the implement 470 downwards, in the direction Y1, from the position or state of FIG. 7A to the position or state of FIG. 7C. The movement of the implement 470 downwards causes the pad 414 to move downwards. In this manner the pad 414 tracks the movement of the pen or implement 470. The pad 414 may lie underneath or above a mouse ball and the movement of the pad 414 may control the movement of a computer cursor on a computer monitor.

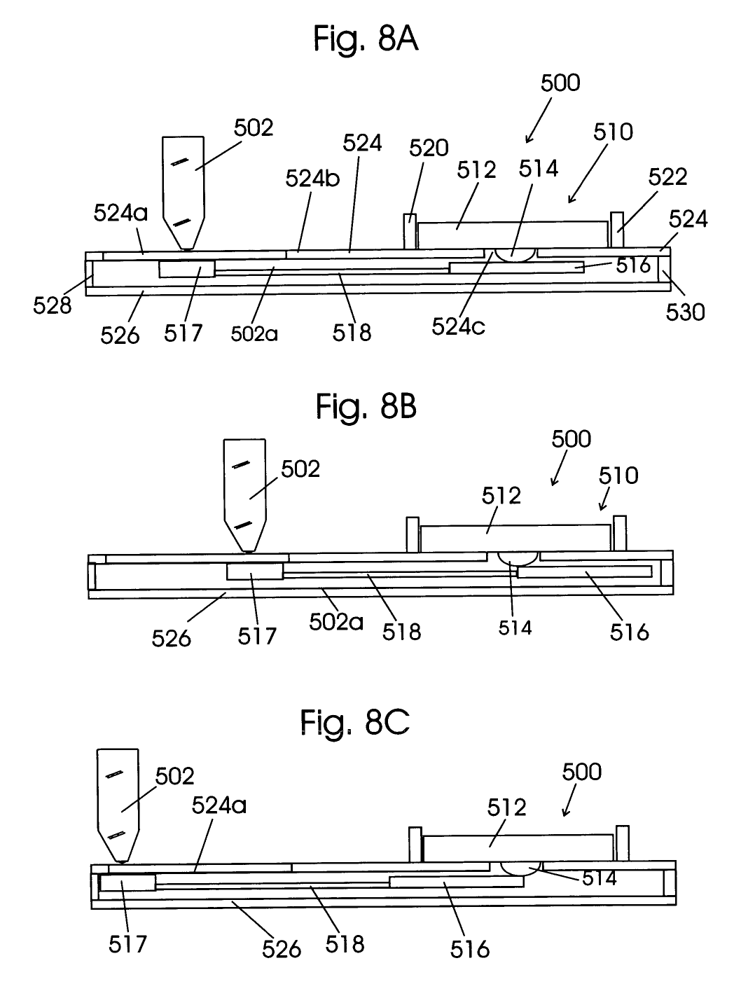

FIG. 8A shows an apparatus 500 in accordance with another embodiment of the present invention wherein an implement 502 is located in a first position with respect to a surface 524. Unlike some of the previous embodiments, the implement 502 need not have any ball, such as ball 124. The apparatus 500 may be comprised of a computer mouse 510, a device 516, walls 520 and 522, a top surface 524, a bottom surface 526, and walls 528 and 530. The top surface 524 may be comprised of portion 524a and portion 524b. The portion 524b may have an opening 524c. The walls 520 and 522, may be used to fix a computer mouse, i.e. in the case of FIG. 8A, computer mouse 510, in a substantially fixed location. The apparatus 500 may have further walls, not shown, which may provide a rectangular box like structure for keeping the computer mouse 510 in a substantially fixed location. The computer mouse 510 may be electrically connected to a computer processor for controlling a cursor on a computer monitor.

The implement 502 may be mechanically connected to the device or pad 516 through devices 517 and 518. The pad 516 may be similar to pad 324. The combination of devices 517 and 518 may be similar to apparatus 300 in FIG. 6A which connects implement 370 and pad 324, or similar to apparatus 400 in FIG. 7A which connects implement 470 and pad 414. the portion 524a may merely be an opening in the surface 524 which allows the implement 502 to be mechanically connected to the device 517. Alternatively, the implement 502 may be connected by magnetism to the device 517 if the portion 524a is a solid surface. Instead of a mechanical method of connection between implement 502 and pad 516, (similar to mechanical connection between implement 370 and pad 324) an electrical connection can be provided. In general the pad 516 should move in response to movement of the implement 502.

As an example, if implement 502 moves right from the position in FIG. 8A to the position in FIG. 8B, then the devices 517 and 518 move to the right causing the device or pad 516 to move to the right. This occurs in the example of FIGS. 7A-7C, where the pad 414 moves to the right with the movement to the right of the implement 470. In the example of FIGS. 6A-6C, the pad or device 324 moves in the opposite direction from the implement 370. In any case the device 516 rotates the ball 514 of the mouse 510 and causes the computer cursor on the computer monitor to be moved.

As another example, if implement 502 moves left from the position in FIG. 8A to the position in FIG. 8C, the devices 517 and 518 move to the left (if devices 517 and 518 follow the example of FIGS. 7A-7C) causes the device or pad 516 to move to the left from the position in FIG. 7A to the position in FIG. 7C. This causes rotation of the ball 514, which causes a cursor on a computer monitor to move to the left.

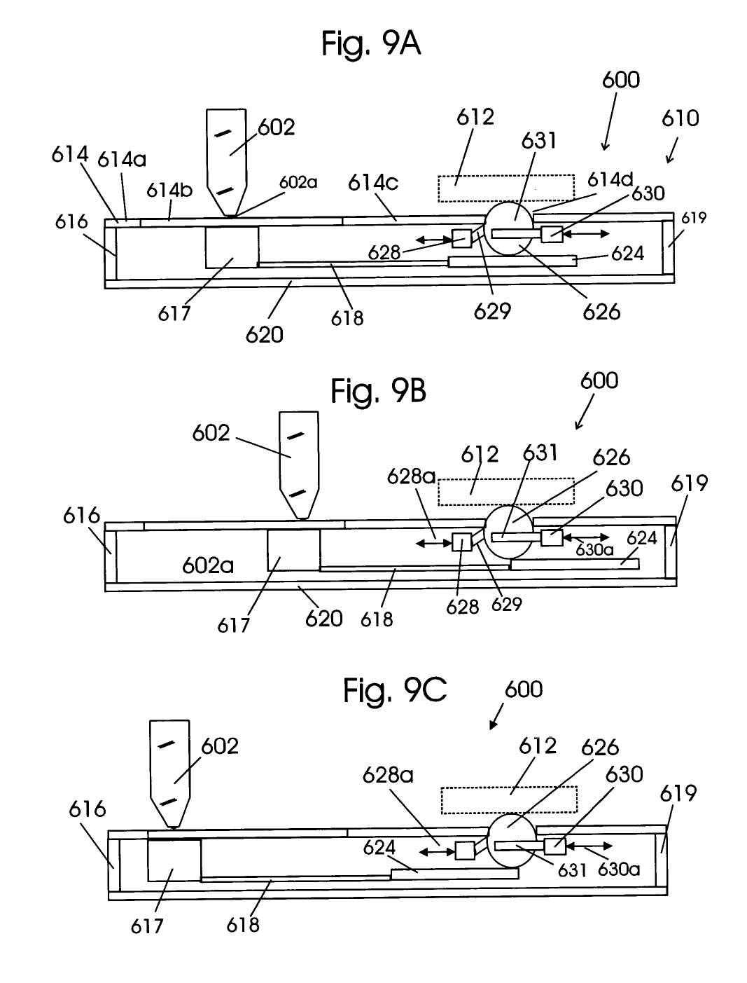

FIG. 9A shows an apparatus 600 of another embodiment of the present invention where an implement 602 is located in a first position with respect to a surface 624. The implement 602 need not have any ball, such as ball 124. The apparatus 600 may be comprised of an optional block 612, and a pad 610. The pad 610 may be comprised of a top surface 614, walls 616 and 618, a bottom surface 620, devices 617, 618, and 624, a ball 626, an X-axis control 629, a device 628, a Y-axis control 631, and a device 630. The top surface 614 may include portions 614a, 614b, and 614c. The top surface portion 614c may have an opening 614d and the ball 626 may peak out of or jut out of the opening 614d as shown in FIGS. 9A-C.

In operation, the implement 602 can be moved to the right from a position shown in FIG. 9A to a position shown in FIG. 9B. The implement 602 may be mechanically connected to the device 617 and movement to the right may cause the devices 617, 618 and 624 to move to the right. The devices 617, 618, and 624 may function in accordance with the principles of FIGS. 6A-6C or FIGS. 7A-7C.

The ball 626 rotates in response to the movement of the device 624. The rotation of the ball 626 causes the rotation of the X and or Y-axis control devices 629, and 631, respectively. In the case of movement in the X-direction to the right, only the X-axis control device 629 would rotate. The rotation of the X axis control device 629 causes the device 628 to generate an electrical signal, which is transmitted via communications line 628a to a computer processor, not shown, for controlling a computer cursor on a computer monitor. The rotation of the Y axis control device 631 causes the device 630 to generate an electrical signal, which is transmitted via communications line 630a to a computer processor, not shown, for controlling a computer cursor on a computer monitor. Movement of the implement 602 from the left to the right, i.e. from FIG. 8A to FIG. 8B causes a computer cursor to move from left to right.

As another example, movement of the implement 602 from the right to the left, from FIG. 9A to FIG. 9C causes a computer cursor to move from the right to the left on a computer monitor.

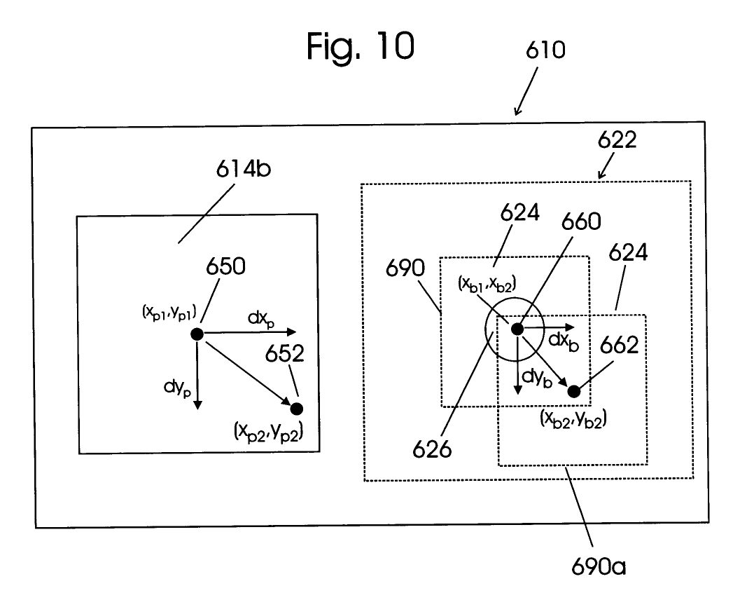

FIG. 10 is a top view diagram which shows the location of some of the components of the apparatus 600 of FIG. 9A at a first instant of time when the tip 602a of the implement 602 is located at a first position 650 and at a second instant of time when the tip 602a of the implement 602 is located at a second position 652. The first position 650 is at a location with coordinates (Xₚ₁, Yₚ₁), while the second position 652 is at a location with coordinates (Xₚ₂, Yₚ₂). The difference between Xₚ₁ and Xₚ₂ is dxₚ and the difference between Yₚ₁ and Yₚ₂ is dyₚ.

FIG. 10 also shows the position of the device (or pad) 624 at two different instants of time. FIG. 9 also shows the position of computer mouse ball 626. When the tip 602a of the implement 602 is located at the first position 650 shown in FIG. 10, then the center of the device 624 is located at the position 660 and the device 624 is located at a position 690. When the tip 602a of the implement 602 is located at the second position 652, then the center of the device 624 is located at the position 662 and the device 624 is located at a position 690a. The center of the device 624 started out at position with coordinates (X_{b1}, Y_{b1}) and ended up at position with coordinates (X_{b2}, Y_{b2}). The difference between the x positions of the device 624 is dx_{b} and the difference between the y positions of the device 624 is dy_{b}. In this example, the device 624 has moved to the same extent and in the same direction as the tip 602a of the implement 602.

The relation between the coordinates X_{b1} and Xₚ₁, and Y_{b1} and Yₚ₁, X_{b2} and Xₚ₂, and Y_{b2} and Yₚ₂ is as follows:

X_{b1}=Xₚ₁+b

Y_{b1}=Yₚ₁+d

X_{b2}=a*dxₚ+Xₚ₁+b

Y_{b2}=c*dyₚ+Yₚ₁+d

In the above equations a, b, c, and d are coefficients. For example, if the position of the tip 602a of the implement 602 has coordinates (0,0) then the center of the ball pad or device 624 would be at coordinates (b, d). Coefficient “a” is the movement transfer ratio for the x-axis, and “c” is the movement transfer ratio for y-axis. For example, if a=1 and c=1, then one inch of movement of the implement 602 will cause the center of the ball pad or device 624 to move one inch in the same direction also. If a=−1 and c=−1, then one inch movement of the tip 602a will cause the ball pad or device 624 to move one inch in the opposite direction. If a=0.5 and c=0.5, then one inch of tip 602a movement will make the center of the ball pad 624 move only 0.5 inch. Thus, coefficient “a” and “c” could be used to control the resolution of implement 602 in terms of a computer cursor to be controlled on a computer monitor, and can also be used to control the size of area of portion 614b in FIG. 10 and the area 622 in FIG. 10. Coefficients “b” and “d” are used to control the location distance from the area of portion 614b in FIG. 10 to the area of device 622 in FIG. 10.

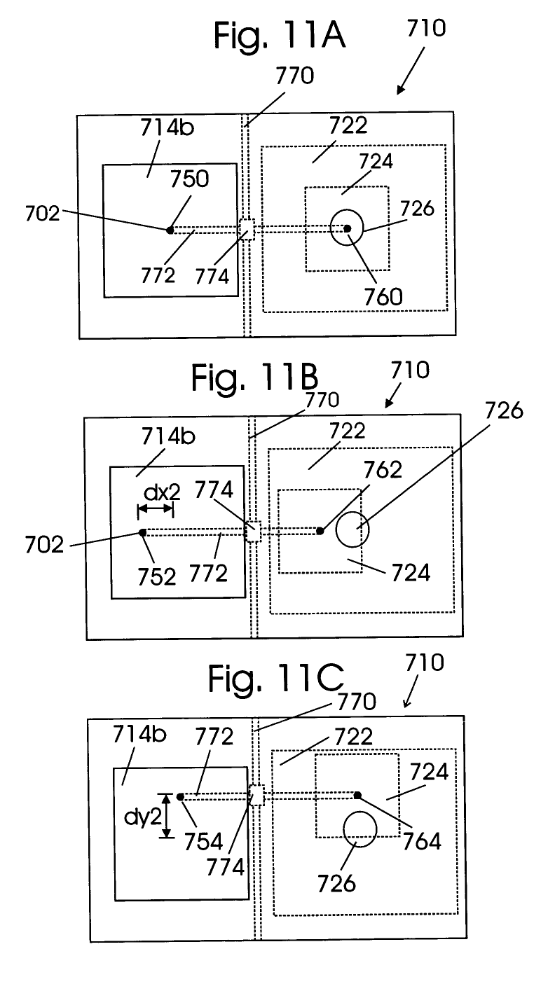

FIG. 11A is a top view diagram of portions of an apparatus 710 in accordance with another embodiment of the present invention wherein a pad or portion 714b of a surface and a first rail 770 and a second rail 772 cause a device 724 to react to movements by an implement 702. A connector 774 allows the rail 772 to slide with respect to the rail 770, which is fixed. A ball 726 of a computer mouse is also shown in FIGS. 11A-C. In operation, when the implement 702 moves, such as from a position 750 in FIG. 11A to a position 752 in FIG. 11 B, the device or pad 724 may also move since it is mechanically connected to implement 702 through rail 772. Rail 770 remains fixed. For example, if the implement 702 moves from right to left, a distance dx2 such as from the position 750 in FIG. 11A to the position 752 in FIG. 11 B, then the rail 772 moves a distance dx2 to the left. One end of the rail 772 is connected to the device 724. When the rail 772 moves from the position of FIG. 11A to the position of FIG. 11 B then the device 724 also moves to the left. The computer mouse ball 726 remains stationary. The movement of the device 724 causes the computer mouse ball 726 to rotate which causes a computer cursor on a computer monitor to move to the left.

As another example, when the implement 702 moves, such as from a position 750 in FIG. 11A to a position 754 in FIG. 11C, the implement 702 causes rail 772 to move upwards a distance dy2. The device 724 also moves upwards a distance dy2, which causes the ball 726 to rotate and causes the computer cursor on the computer monitor (not shown) to move upwards.

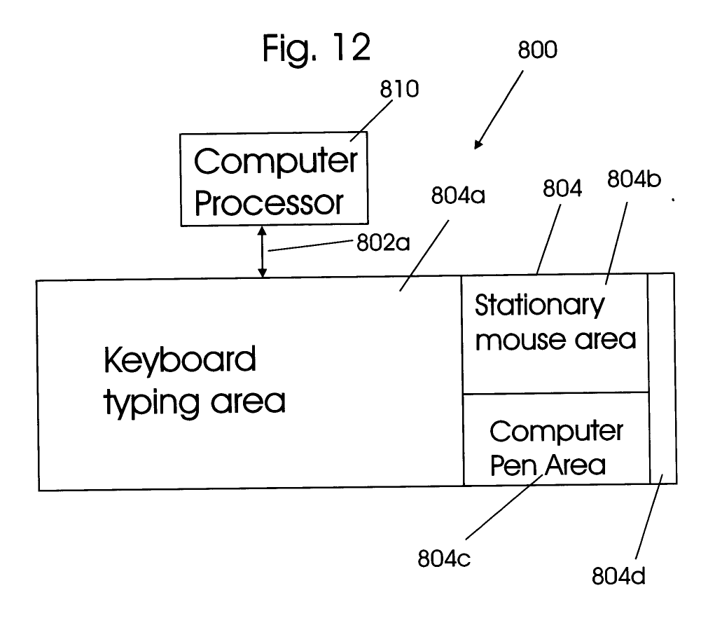

FIG. 12 is a block diagram of a first keyboard device 800 in accordance with another embodiment of the present invention. The first keyboard device 800 may be comprised of a keyboard typing area 804a, a stationary mouse area 804b, a computer pen area 804c, and a computer pen holder area 804d. The computer pen holder area 804d may be a switch like the switch or device 206 shown in FIG. 4. The keyboard typing area 804a may be comprised of keys found in a typical prior art keyboard for a personal computer. The first keyboard device 800 may be electrically connected to a computer processor 810 by a communications line 802a. Inputs from the keyboard area 804a, the stationary mouse area 804b, and the computer pen area 804c may be sent via the communications line 802a to the computer processor 810.

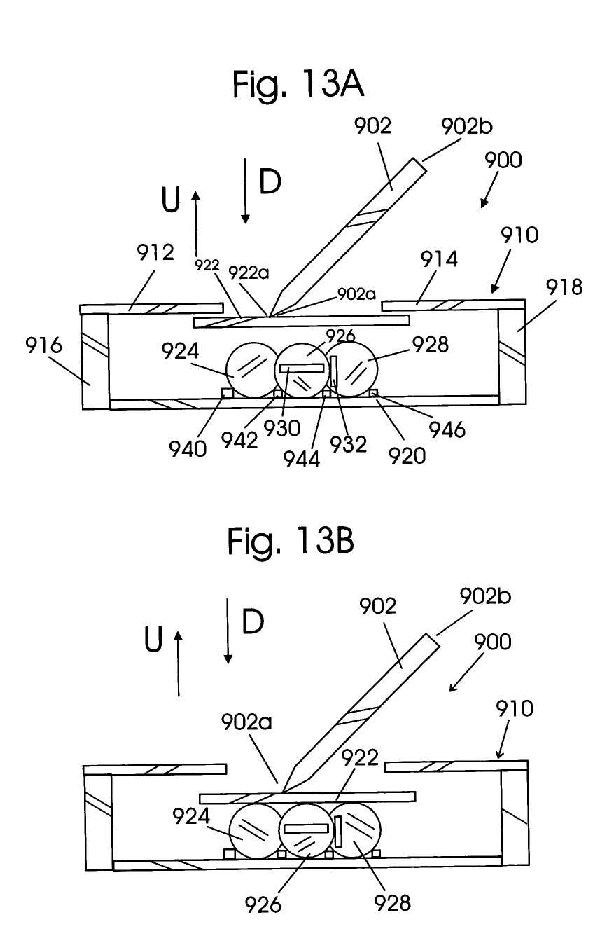

FIG. 13A is a side view of components of another embodiment in accordance with the present invention with pressure not applied to an implement 902. FIG. 13A shows apparatus 900. The apparatus 900 is comprised board 910. The board 910 is comprised of portions 912, 914, 916, 918, and 920. The apparatus 900 is further comprised of pad 922, and balls 924, 926, and 928. The apparatus 900 is further comprised of X-axis control device 930 and Y-axis control device 932, and tracks or rails 940, 942, 944, and 946. The tracks or rails 940, 942, 944, and 946 and other optional tracks or rails, keep the balls 924, 926, and 928 in the same position as shown in FIGS. 13A and 13B. The balls 924, 926, and 928 thus can rotate but do not move translationally.

FIG. 13B is a side view of the components of FIG. 13A with pressure applied to the implement 902 of FIG. 13A. The implement 902 is physically connected to the pad 922 at an end 902a and at a location 922a of the pad 922. When pressure is not applied to the implement 902 the pad 922 may move upwards in the direction U shown in FIG. 13A. The pad 922 may normally, in the absence of pressure applied in the direction D by implement 902, be forced to move upwards, in the direction U, by a magnetic attraction between portion 912 and pad 922 and between portion 914 and pad 922. When pressure is applied by the implement 902, the pad 922 is forced downwards in the direction D, as shown in FIG. 13B. The pad 922 can be forced downwards on top of the balls 924, 926, and 928. The pad 922 can then move horizontally while frictionally engaging the balls 924, 926, and 928, to cause the balls 924, 926, and 928 to rotate. The balls 924 and 928 may be used merely to stabilize the pad 922. The rotation of the ball 926 may cause the rotation of the X-axis control device 930 and the Y-axis control device 932 to control a computer cursor on a computer monitor.

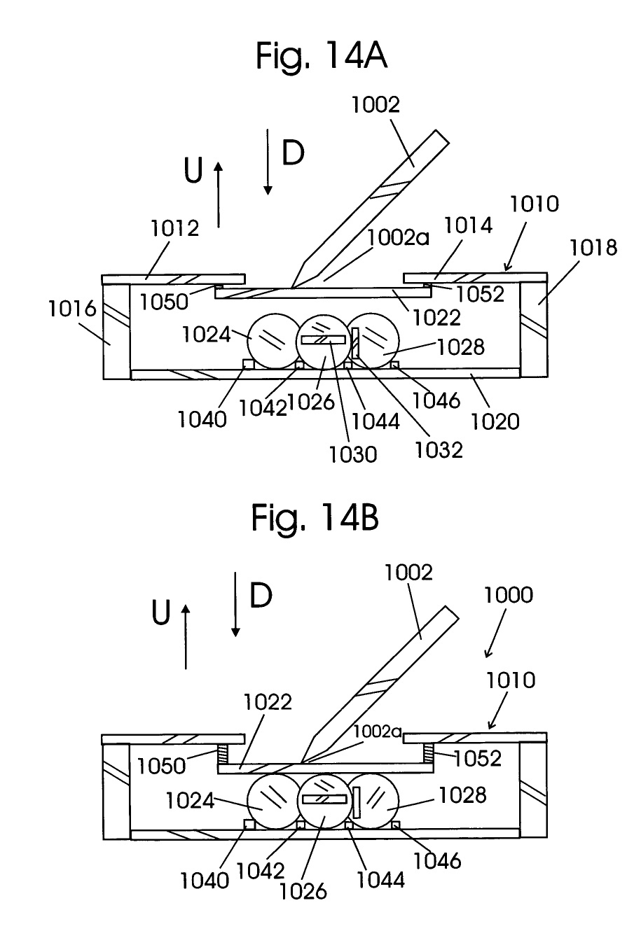

FIG. 14A is a side view of components of another embodiment in accordance with the present invention with no pressure applied to an implement 1002. FIG. 14A shows apparatus 1000. The apparatus 1000 is comprised board 1010. The board 1010 is comprised of portions 1012, 1014, 1016, 1018, and 1020. The apparatus 1000 is further comprised of pad 1022, and balls 1024, 1026, and 1028. The apparatus 1000 is further comprised of X-axis control device 1030 and Y-axis control device 1032, and tracks or rails 1040, 1042, 1044, and 1046. The tracks or rails 1040, 1042, 1044, and 1046 and other optional tracks or rails, keep the balls 1024, 1026, and 1028 in the same position as shown in FIG. 14A and 14B. The balls 1024, 1026, and 1028 thus can rotate but do not move translationally. The apparatus 1000 also includes spring 1050 and spring 1052. Springs 1050 and 1052 are shown in a normal, at rest state in FIG. 14A. i.e., in the absence of some force, the springs 1050 and 1052 will tend to put the pad 1022 in the position shown in FIG. 14A with respect to the portions 1012 and 1014, where the pad 1022 does not contact the balls 1024, 1026, and 1028.

FIG. 14B is a side view of the components of FIG. 14A with pressure applied to the implement 1002 of FIG. 14A. The implement 1002 is physically connected to the pad 1022 at an end 1002a and at a location 1022a of the pad 1022. When pressure is not applied to the implement 1002 the pad 1022 may move upwards in the direction U shown in FIG. 14A. The pad 1022 may normally, in the absence of pressure applied in the direction D by implement 1002, be forced to move upwards, in the direction U, by the springs 1050 and 1052. When pressure is applied by the implement 1002, the pad 1022 is forced downwards in the direction D, as shown in FIG. 14B. The pad 1022 can be forced downwards on top of the balls 1024, 1026, and 1028. The pad 1022 can then move horizontally while frictionally engaging the balls 1024, 1026, and 1028, to cause the balls 1024, 1026, and 1028 to rotate. The balls 1024 and 1028 may be used merely to stabilize the pad 1022. The rotation of the ball 1026 may cause the rotation of the X-axis control device 1030 and the Y-axis control device 1032 to control a computer cursor on a computer monitor.

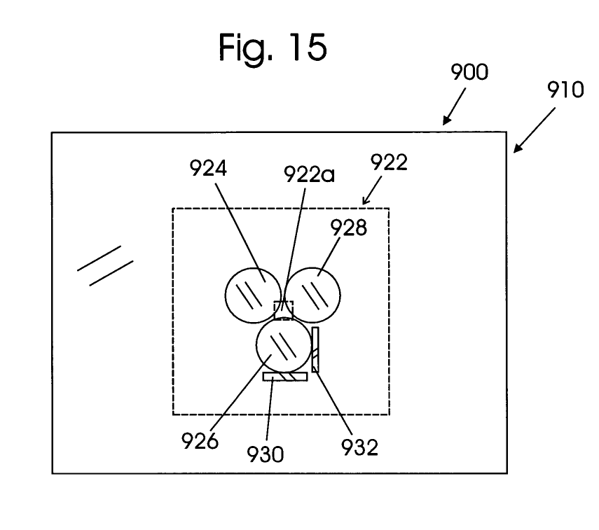

FIG. 15 is a top view of components of the embodiment of FIGS. 13A and 13B. FIG. 15 shows portions of apparatus 900 including board 910. FIG. 15 shows the location of pad 922 in dashed lines. Normally pad 922 would be solid and one would not be able to see balls 924, 926, and 928 from the top view. The general location of the point 922a where the pad 922 physically connects with the implement 902 is also shown in dashed lines. The location of the X-axis control device 930 and 932 is also shown.

In both FIGS. 13A-B and FIGS. 14A-B a pad, such as 922 and 1022 sits on top of three balls, such as 924, 926, and 928 or 1024, 1026, and 1028. The pad, such as 922 or 1022, is moved to rotate the balls beneath the pad. Two of the balls, such as 924 and 928 or 1024 and 1028, provide for balance and support of the pad 922 or 1022, while the third ball 926 or 1026 controls rotation of the X-axis control device, such as 930 or 1030 and the Y-axis control device, such as 932 or 1032. An implement, such as 902 or 1002 can be used to move the pad, such as 922 or 1022, or either of the pads 922 or 1022 can be moved with a person's finger.

The embodiments of FIGS. 13A-B or FIGS. 14A-B can be implemented in a computer keyboard, inside a computer mouse, inside a computer mouse pad or board, or as an independent device.

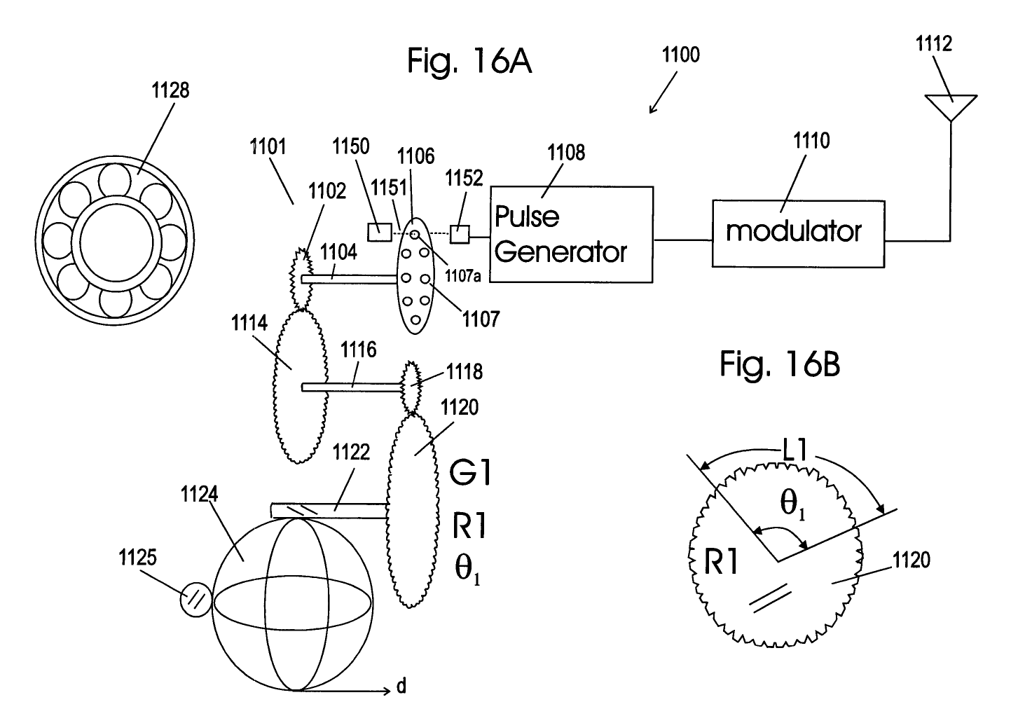

FIG. 16A is a diagram of an apparatus 1100 in accordance with another embodiment of the present invention. The apparatus 1100 includes a gear 1102, an axis 1104, a disc 1106, a pulse generator 1108, a modulator 1110, a transmitter 1112, a gear 1114, an axis 1116, a gear 1118, a gear 1120, a Y-axis control device 1122, an X-axis control device 1125, and a ball 1124. FIG. 16B shows a right side view of gear 1120, In FIG. 16B,θ₁ is the rotated angle of 1120, R1 is radius of 1120, L1 is a linear displacement of rotation of angle θ₁. FIG. 16A also shows bearing gear 1128. A plurality of bearing gears 1128 can be provided so that a bearing gear 1128 is provided and used on and with each of axises or axles 1104, 1116 and 1122 to reduce friction when the particular axis is rotating.

FIG. 16A shows a special mechanical gear chain 1101, which greatly improves the resolution of a computer pen-shaped apparatus in accordance with the present invention. The gear chain 1101 is comprised of gears 1120, 1118, 1114, and 1102.

As the idle ball or ball 1124 moves a linear distance d (in this case translationally), the gear chain (comprised of gears 1102, 1114, 1118, and 1120) allows the disc 1106 to have a larger linear displacement of rotation.

All gears (gears 1120, 1118, 1114, and 1102) used in this chain are spur gears, and each of the gears is comprised of a wheel with teeth cut along the circumference. When the idle ball 1124 rotates, it frictionally engages axis 1122. Since axis 1122 is connected and concentric to large gear 1120, both axis 1122 and large gear 1120 have the same angular displacement. Thus, as the idle ball 1124 rotates a linear distance of d, both axis 1122 and gear 1120 rotate an angle of _{θ}1. Since d equals the linear displacement of axis 1122, _{θ}1 equals d divided by the radius, r1, of the axis 1122.

$${θ}_{1} = \frac{d}{{r}_{1}} \qquad ( 1 )$$

Then, as gear 1120 rotates _{θ}1 radians, its linear displacement, L1, equals its angular displacement times its radius:

$${L}_{1} = {θ}_{1} {R}_{1} = \frac{{R}_{1}}{{r}_{1}} d > d \qquad ( 2 )$$

Since R1 is greater than r1, the linear displacement, L1, moved by the spur gear 1120, is greater than d, the linear distance rotated by the idle ball 1124. Next, as gear 1120 rotates, its teeth engage a smaller spur gear, gear 1118. Gear 1118 has the same linear displacement or rotation L1 as gear 1120. However, gear 1118 will rotate faster than gear 1120. Gear 1118 is connected and concentric to a larger gear 1114. Thus, gear 1118 and gear 1114 have the same angular displacement, _{θ}2, which equals:

$${θ}_{2} = \frac{{L}_{1}}{{r}_{2}} \qquad ( 3 )$$

Then, as gear 1114 rotates _{θ}2 radians, its linear displacement, L2, equals its angular displacement times its radius:

$${L}_{2} = {θ}_{2} {R}_{2} = \frac{{L}_{1}}{{r}_{2}} {R}_{2} = \frac{{R}_{1} {R}_{2}}{{r}_{1} {r}_{2}} d > {L}_{1} > d \qquad ( 4 )$$

By comparing equation (4) and equation (2), it can be seen that gear 1114 has a larger linear displacement of rotation than gear 1120. More generally, this analysis proves a rule: When a large gear rotates a smaller gear, which is connected and concentric to another large gear, the second large gear will have a larger angular and linear displacement of rotation than the first large gear.

This is an important aspect to this proposed mechanical gear chain 1101 as shown in FIG. 16A. In fact, every addition of a larger gear rotating a smaller gear will allow the disc 1106, connected at the end of the chain (comprised of gears 1120, 118, 114, and 1102), to have a larger linear displacement by a factor of R/r, where R and r are the radii of the larger and smaller gear, respectively:

$${L}_{n} = \frac{{R}_{1} {R}_{2} {R}_{3} ⋯ {R}_{n}}{{r}_{1} {r}_{2} {r}_{3} ⋯ {r}_{n}} d \geq \frac{2 π {R}_{n}}{N} \qquad ( 5 )$$

In equation (5), Lₙ is the linear displacement of the last wheel in the chain, which must be the disc 1106. The purpose of the mechanical gear chain 1101 (comprised of gears 1102, 1114, 1118, and 1120) is to increase the linear displacement of the disc 1106 so that even a very small linear displacement d of the idle ball 1124 d will cause the linear displacement of the disc 1106 to be large.

The apparatus 1100 in FIG. 16A includes an infrared LED (light emitting diode) transmitter 1150 and an infrared LED receiver 1152. The transmitter 1150 emits light beam 1151 (shown by dashed lines) which may pass through for example opening 1107a and may be received and detected by receiver 1152.

The disc 1106 includes a plurality of holes 1107, which include hole 1107a. The linear displacement of the disc 1106 always has to be large enough so that a light beam from transmitter 1150 will pass through one hole, such as hole 1107a, and then into through the receiver 1152 to cause the pulse generator 1108 to generate a pulse. Thus, the minimum linear displacement of the disc 1106 will always have to be larger than the distance between two adjacent holes,

$$\frac{2 π {R}_{n}}{N} ,$$

where N is the number of holes on the disc 1106 and Rₙ is the radius of the disc 1106. Rewriting equation (5) with d on one side of the inequality gives:

$$d \geq \frac{2 π {R}_{n}}{N} \frac{{r}_{1} {r}_{2} {r}_{3} ⋯ {r}_{n}}{{R}_{1} {R}_{2} {R}_{3} ⋯ {R}_{n}} \qquad ( 6 )$$

This equation summarizes the ability for this proposed mechanical gear chain 1101 to greatly improve the resolution of a computer pen-like or pen shaped device in accordance with an embodiment of the present invention. Since r is smaller than R, the addition of one set of large and small gears to the gear chain will greatly decrease the minimum distance of d. For example, r=5 mm (millimeters), R=15 mm (millimeters), N=64 and no gear is a typical design for existing mouse, which provides a minimal resolution of

$${d}_{min} = \frac{2 π R}{N} \frac{r}{R} = \frac{2 π * 5}{64} \approx 0.5 mm \qquad ( 7 )$$

This means, to detect one pulse, the mouse has to move at least 0.5 mm.

With the proposed movement chain, we can design: n=3, N=50, r₁=r₂=r₃=3 mm, R₁=R₂=R₃=13 mm, then the resolution will be

$${d}_{min} = \frac{2 π {R}_{3}}{N} \frac{{r}_{1} {r}_{2} {r}_{3}}{{R}_{1} {R}_{2} {R}_{3}} = \frac{2 π \cdot 13}{50} \cdot \frac{3 \cdot 3 \cdot 3}{13 \cdot 13 \cdot 13} \approx 0.02 mm \qquad ( 8 )$$

If n=4, the resolution be can further reduced to dₘᵢₙ=0.005 mm, which is 100 times higher than regular mouse.

Next, wireless technology is used to make the computer pen as portable as a regular pen as shown in FIGS. 16A, 16B, 17A, 17B, 18, and 19. An important principle here is that the pulse generated by the original infrared sensors that detect disc rotation, such as disc 1106 will directly be modulated to and transmitted by another wireless transmitter (i.e. another infrared LED) inside the pen. A wireless receiver (i.e. another infrared sensor) is placed in a separate station close to the pen. The circuits or processor to process the pulse information and cursor movement information is also inside the station, which connects to the computer. Thus, there will be fewer components inside the wireless pen.

Optical computer mice, which are known in the art, have an optical transmitter that bounces light off a surface, on which a computer mouse sits, onto an optical receiver. The optical receiver picks up most of the light given off by the optical transmitter, so that, effectively, the receiver forms an image of the surface. As the mouse moves over a surface, the receiver detects different images. The receiver sends each image to a digital signal processor (DSP), which detects patterns in the images and determines how those patterns have moved since the previous image. By determining how far those patterns have moved, the DSP is able to determine how far the mouse has moved, and thus how far the cursor will move on screen.

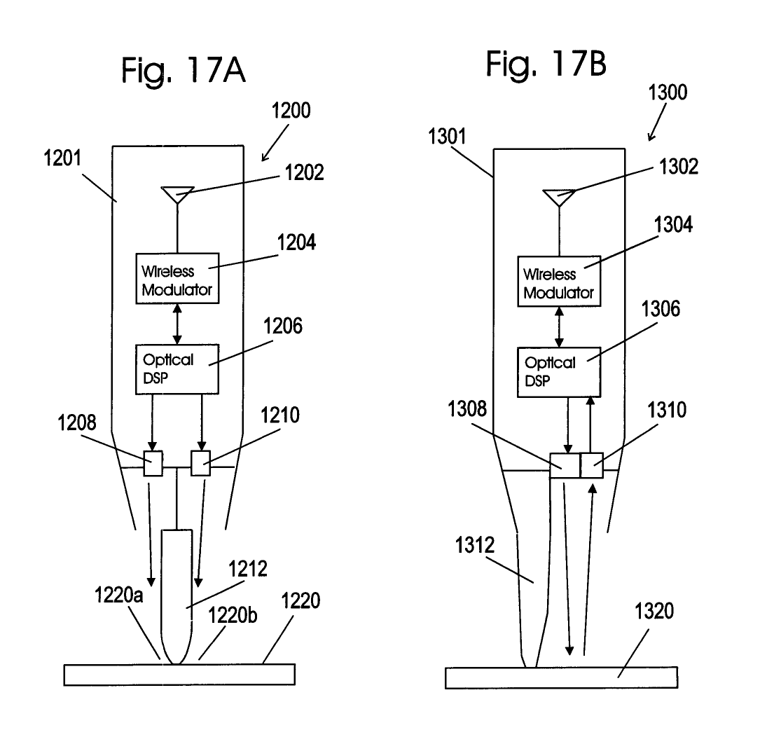

FIG. 17A shows an optical pen-like apparatus 1200 in accordance with the present invention which uses, to some degree, optical mouse technology.

FIG. 17A is a diagram of a pen like or pen shaped apparatus 1200 with a symmetric pen tip 1212 in accordance with another embodiment of the present invention. The apparatus 1200 also includes a pen shaped housing 1201, a wireless transmitter 1202, a wireless modulator 1204, an optical digital signal processor 1206, a transmitter 1208, a receiver 1210, and the symmetric pen tip 1212. The apparatus 1200 is shown being applied against a surface 1220, which may be a surface of a typical computer mouse pad known in the art.

In the apparatus 1200, the optical transmitter 1208 and the optical receiver 1210 are located near the pen tip 1212. The pen tip 1212 extends out of the pen-like apparatus 1200 so that the optical transmitter 1208 and the optical receiver 1210 can be exposed to the outside. The optical transmitter 1208 and the optical receiver 1210 create an image of surface areas, such as surface area 1220a and 1220b, on the surface 1220, near the pen tip 1212. The DSP 1206 processes the movement of the image. FIG. 17A shows a pen-like apparatus 1200 with a symmetric pen tip 1212. The advantage is that apparatus 1200 looks like a regular pen. However, red light from the optical transmitter 1208 reflects to the eye; and can be uncomfortable. Another disadvantage of the embodiment of FIG. 17A is that the optical transmitter 1208 and the optical receiver 1210 are exposed to the outside and can easily become dirty.

FIG. 17B shows an improvement to the FIG. 17A embodiment, with an asymmetric pen tip 1312, in accordance with another embodiment of the present invention. The apparatus 1300 also includes a pen shaped housing 1301, a transmitter 1302, a wireless modulator 1304, an optical digital signal processor 1306, a transmitter 1308, a receiver 1310, and the asymmetric pen tip 1312. The apparatus 1300 is shown being applied against a surface 1320 in FIG. 17B. The surface 1320 may be the surface of a conventional computer mouse pad.

In the FIG. 17B embodiment, the optical transmitter 1308, and the optical receiver 1310 are placed behind the pen tip 1312, so that red light from the transmitter 1308 is blocked from the user. Pen tip 1312 may use non-transparent material. Although its tip point that contacts surface 1320 is very small, the other parts of the pen tip that connect to the pen housing 1301 may be big enough so that the pen tip 1312 can block light from transmitter 1308. Both transmitter 1308 and receiver 1310 are exposed to outside of pen housing 1301 while not covered by pen tip. When pen tip 1312 moves over the surface 1320, the transmitter 1308 sends out light, it bounces off of the surface 1320, and returns back to the optical receiver 1310. The optical DSP 1306 processes the different images from receiver 1310 and calculates the movement information of the pen tip 1312. This information is further modulated by wireless modulator 1304, and then wireless transmitter 1320 sends out the information to a receiver station that is connected to computer.

Although FIG. 17B solves the problem of light reflecting to a person's eye, it still has a problem that there is no cover on the tip 1312 and therefore the pen or apparatus 1300 can easily become dirty.

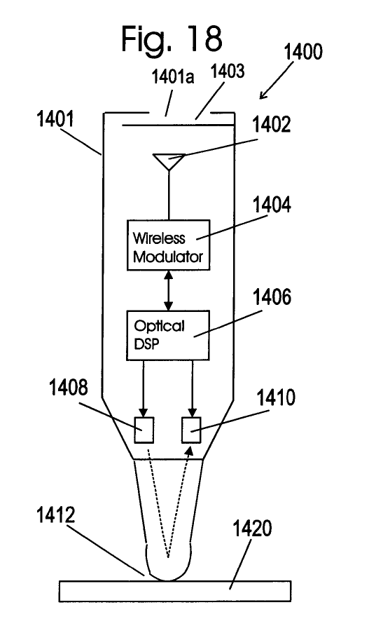

FIG. 18 shows the improvement to the FIG. 17A and FIG. 17B embodiments, with a full covered pen tip 1412 in accordance with another embodiment of the present invention. The apparatus 1400 also includes a pen shaped housing 1401, a wireless transmitter 1402, a wireless modulator 1404, an optical digital signal processor 1406, a transmitter 1408, a receiver 1410, and pen tip 1412. The apparatus 1400 is shown being applied against a surface 1420, which may be a surface of a typical computer mouse pad known in the art.

In the apparatus 1400, the optical transmitter 1408 and the optical receiver 1410 are located inside the pen tip 1412. The pen tip 1412 is also a cover so that no dust can get into the pen. The pen tip 1412 is made of full transparent material so that the optical transmitter 1408 may send out light, and it may go through the transparent pen tip cover 1412 to surface 1420, and bounce back to receiver 1410 through cover 1412. The optical transmitter 1408 and the optical receiver 1410 create an image of surface areas, such as surface area 1420, near the pen tip 1412. The DSP 1406 processes the movement of the image.

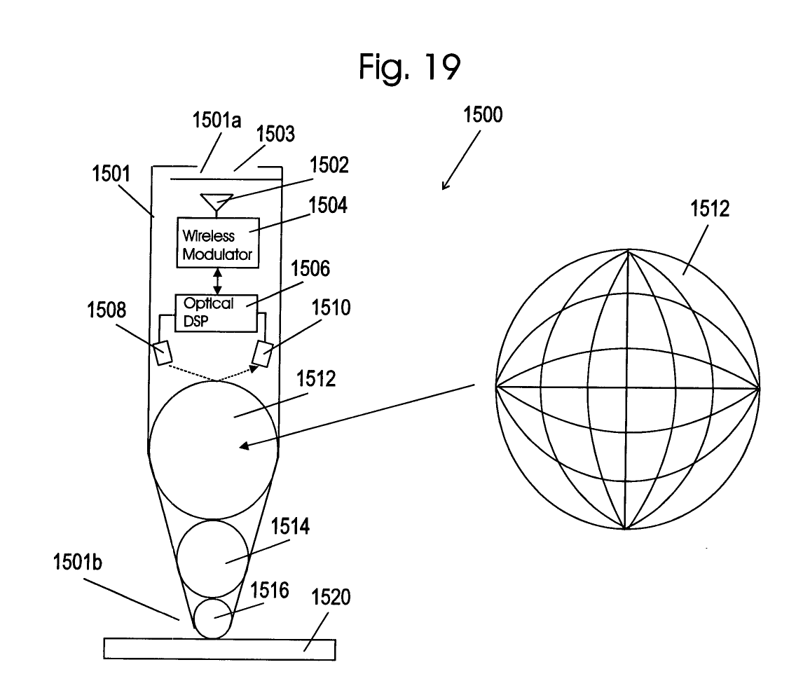

FIG. 19 is a diagram of a pen like apparatus 1500 with a heat release window 1501a and X and Y axis coding balls 1512, which could use any kind of coding on the ball to distinguish the image patterns when a pen tip 1501b is moving against a surface 1520. FIG. 19 shows a closeup of the ball 1512 with an exemplary X- and Y-axis bar coding. The apparatus 1500 also includes a housing 1501, a transmitter 1502, a member 1503, a wireless modulator 1504, an optical digital signal processor 1506, a transmitter 1508, a receiver 1510, a ball 1512, a ball 1514, a ball 1516, and a surface 1520.

In the embodiment of FIG. 19, light from the optical transmitter 1508 is concealed from the user. This is achiever by hiding or enclosing the optical transmitter 1508 and the optical receiver 1510 inside the pen housing 1501. The FIG. 19 embodiment may use one or more idle balls. The ball 1512, may have any coding or pattern on it. One example is bar coding represented by latitudinal and longitudinal lines. Typically bars of a bar code have different widths and different distances between adjacent bars. The optical transmitter 1508 and the optical receiver 1510 are located above the ball 1512 and the optical receiver 1510 takes an image from the top of the ball 1512 in FIG. 19. The coding on the ball 1512 provides unique images to the ball 1512 for all positions. Thus, the DSP, such as 1516, can easily determine the movement of the ball 1512, and thus, the movement of the apparatus 1500. Since all light is produced inside the pen 1500, a lot of heat builds up inside. Therefore, a heat-released window 1501a is designed, as shown in FIG. 19. In practice, the heat-released window 1502a could be placed in any location of the pen housing 1501, such as on the side of pen housing 1501.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

I claim:

1. An apparatus comprising
an optical transmitter;
an optical receiver; and
a pen shaped housing in which the optical transmitter and the optical receiver are located.

2. The apparatus of claim 1 further comprising
a processor;
wherein the optical transmitter sends out optical signals toward a surface and the optical receiver receives the optical signals reflected off of the surface; and
wherein the processor processes the optical signals received by the optical receiver to determine the location of the pen shaped housing.

3. The apparatus of claim 2 wherein
the processor processes the optical signals received by the optical receiver to determine the location and movement of the pen shaped housing.

4. The apparatus of claim 1 further comprising
a processor;
wherein the optical transmitter sends out optical signals toward a surface and the optical receiver receives the optical signals reflected off of the surface; and
wherein the processor processes the optical signals received by the optical receiver to determine the movement of the pen shaped housing.

5. The apparatus of claim 2 further comprising
a tip;
wherein the optical transmitter sends out optical signals towards an area near the tip, and the optical receiver receives optical signals reflected off an area near the tip.

6. The apparatus of claim 5 wherein
the tip is centered at one end of the pen shaped housing.

7. The apparatus of claim 5 wherein
the tip is asymmetrically located at one end of the pen shaped housing.

8. The apparatus of claim 2 further comprising
a wireless transmitter;
wherein the wireless transmitter transmits wireless signals specifying the location of the pen shaped housing based on the received optical signals processed by the processor.

9. The apparatus of claim 2 further comprising
a wireless transmitter; and
wherein the wireless transmitter transmits wireless signals specifying the movement of the pen shaped housing based on the received optical signals processed by the processor.

10. The apparatus of claim 9 further comprising
a wireless modulator; and
wherein the wireless modulator supplies the wireless signals to the wireless transmitter based on the received optical signals processed by the processor.

11. The apparatus of claim 1 wherein
the pen shaped housing has a tip which is closed.

12. The apparatus of claim 11 wherein
the pen shaped housing includes a heat release window.

13. The apparatus of claim 11 wherein
the tip is transparent.

14. The apparatus of claim 1 wherein
the pen shaped housing has a tip which is partially transparent and partially opaque.

15. The apparatus of claim 1 further comprising
a first ball having a surface; wherein the optical transmitter sends out optical signals toward a surface of the first ball and the optical receiver receives the optical signals reflected off of the surface of the first ball; and
wherein the processor processes the optical signals received by the optical receiver to determine the movement of the pen shaped housing.

16. The apparatus of claim 15 wherein
the surface of the first ball has coding on it;
the pen shaped housing has a pen tip; and
wherein the coding allows the processor to distinguish images reflected off of the surface when the pen tip is moving.

17. The apparatus of claim 1 further comprising
a plurality of balls located inside of the pen shaped housing.

18. A method comprising
sending out optical signals toward a surface;
receiving the optical signals reflected off of the surface; and
processing the optical signals received to determine the location of a pen shaped housing.

19. The method of claim 18 further comprising
sending out optical signals towards an area near a tip of the pen shaped housing; and
receiving optical signals reflected off an area near the tip of the pen shaped housing.

20. The method of claim 19 wherein
the tip is centered at one end of the pen shaped housing.

21. The method of claim 20 further comprising
transmitting wireless signals specifying the location of the pen shaped housing based on the received optical signals.

22. The method of claim 21 further comprising
modulating the received optical signals; and
supplying the wireless signals to the wireless transmitter based on the modulated received optical signals.

23. The method of claim 18 wherein
the pen shaped housing has a tip which is closed.

24. The method of claim 18 wherein
the pen shaped housing includes a heat release window.

25. The method of claim 23 wherein
the tip is transparent.

26. The method of claim 18 wherein
the pen shaped housing has a tip which is partially transparent and partially opaque.

27. The method of claim 18 wherein
the surface is part of a first ball.

28. An apparatus comprising
a first gear;
a disc having a first hole;
an optical transmitter;
an optical receiver; and
a first ball;
and wherein when the first ball rotates, the first ball causes the first gear to rotate which causes the disc to move, which causes light from the optical transmitter to be passed through the first hole of the disc and to be received by the optical receiver.
